(19) United States
(12) Patent Application Publication
(10) Pub. No.: US 2024/0417490 A1
(43) Pub. Date: Dec. 19, 2024

(54) METHOD FOR PRODUCING AN ALGINATE-BASED FILM AND ALGINATE-BASED FILM

(71) Applicants: MUJO LAB OHG, Berlin (DE); PAPIERTECHNISCHE STIFTUNG (PTS), Heidenau (DE)

(72) Inventors: Annekathrin GRÜNEBERG, Berlin (DE); Juni Sun NEYENHUYS, Berlin (DE); Martin ZAHEL, Dresden (DE); Birgit KIESSLER, Dresden (DE)

(73) Assignees: MUJO LAB OHG, Berlin (DE); PAPIERTECHNISCHE STIFTUNG (PTS), Heidenau (DE)

(21) Appl. No.: 18/703,349

(22) PCT Filed: Oct. 21, 2022
(86) PCT No.: PCT/EP2022/079419

§ 371 Date: Apr. 21, 2024

(30) Foreign Application Priority Data
Oct. 22, 2021 (DE) 10 2021 127 569.5

(51) Int. Cl. C08B 37/00; C08J 3/24; C08J 5/18; C08K 3/011; C08K 5/00

(52) U.S. Cl. CPC C08B 37/0084; C08J 3/24; C08J 5/18; C08K 3/011; C08K 5/0016; C08J 2305/04

(57) ABSTRACT

The invention relates to a method for producing an alginate-based film with the method steps of preparing a mixture, the mixture comprising alginate, plasticizer and solvent as constituents; spreading the mixture flatly; and drying the mixture, characterized in that the mixture contains a crosslinking control agent. The invention further relates to an alginate-based film for use as packaging material, containing: crosslinked alginate, plasticizer and solvent, characterized in that the alginate-based film additionally contains salts which are formed by the solvent and a crosslinking control agent.

The invention relates to a method for producing an alginate-based film with the method steps of producing a mixture, the mixture comprising the components alginate, plasticizer and solvent, spreading the mixture flatly over an area and drying the mixture, characterized in that the mixture is a crosslinking system consisting of a crosslinking agent and a crosslinking control agent. The invention further relates to an alginate-based film for use as a packaging material, which has: crosslinked alginate, plasticizers and solvents, characterized in that the alginate-based film additionally has substances that are formed by chemical reactions between the components of the mixture.

### PRIOR ART

Alginate or its protonated form alginic acid is the main supporting and structural polysaccharide of many marine brown algae and is a biopolymer. These are sustainably produced and ecologically attractive raw materials which offer an opportunity at least partially to replace products with a problematic environmental impact (e.g. plastics) in view of increasingly scarce resources and substances and processes in current use that are harmful to the environment and health. Another advantage is the use of aqueous solvents for the production and processing of alginate-based biopolymers; no solvent vapors or waste that are harmful to the environment and health are produced. The ability of alginates to form membranes and films opens up numerous perspectives for applications, particularly in the packaging industry.

The documents U.S. Pat. Nos. 2,485,512 A and 2,030,566 A disclose methods for producing such alginate-based films. Solvent (water) is added to the alginate at the beginning of the production process. The initial alginate solution is then applied to a roller system immediately after the mixing process and rolled out into a film. A crosslinking agent is then added to this in an immersion bath, so that crosslinking begins immediately. In addition, ecologically problematic substances such as ammonium and alkaline hydroxides are also used as solvents. At the same time, the method is very complex and the production of the alginate-based films is therefore comparatively cost-intensive.

It is therefore an object of the present invention to provide a method for producing an alginate-based film with which continuous, rapid and cost-effective production of the alginate-based film is possible, wherein the production can be easily, flexibly and quickly adapted to different requirements for the alginate-based film.

It is also an object of the invention to provide an alginate-based film for use as a packaging material that is biodegradable and at the same time inexpensive to produce.

The stated object is achieved by means of the method for producing an alginate-based film according to claim 1. Advantageous embodiments of the invention are set out in the dependent claims.

The process according to the invention for producing an alginate-based film includes three method steps: In the first method step, a mixture is produced, the mixture comprising the components alginate, plasticizer, crosslinking agent, crosslinking control agent and solvent.

Brown algae containing alginate and bacterially derived alginate are used for production. The alginate varies in its molecular structure because it is a natural product. The alginate is contained together with cellulose in the cell walls of brown algae and has short-chain and long-chain molecules (molecular weight distribution). For the production of films, it is important to adjust the molecular weight distribution so that, on the one hand, the solids content of the mixture can be kept as high as possible with a lower viscosity for good processability (shorter molecules), but at the same time the mechanical properties of the film are sufficient for the target application (longer molecules). Alginate has two types of monomers, mannuronic acid and guluronic acid, also called G blocks and M blocks. The alginate used in the method according to the invention for producing an alginate-based film contains M and G blocks in a ratio of preferably about 1:1.

The crosslinking agent acts in such a way that carboxyl groups of the alginic acid polymers, which are found in both G and M blocks, are ionically bridged by the crosslinking agent. The crosslinking agent is therefore preferably a salt with multivalent metal ions, which can be well or poorly or not soluble in the solvent. The divalent Ca ion is preferably used to crosslink the alginate polymers. The resulting crosslinking with calcium is based on an ionic bond that is weaker than the covalent bond, which facilitates the biodegradation process. At the same time, crosslinking also ensures that water insolubility is achieved, which is important for many material applications.

Plasticizers are suitable for reducing the glass transition temperature as well as the hardness and brittleness of a plastic. Therefore, such an additive (external plasticizer) makes the plastics mixed with it easier to process and shape, more elastic and flexible. These properties are particularly important for packaging materials. Plasticizers work by being incorporated into the polymeric material structure, leading to an increase in chain mobility. It is important for this purpose that, on the one hand, the plasticizer can act as a solvent for the polymer and, on the other hand, it has a low vapor pressure so that the long-term stability of the material is not negatively affected by sweating or evaporation. For this reason, various different low-molecular-weight substances or oligomers are used. The most frequently used plasticizer in conventional plastics is, for example, diethylhexyl phthalate (DEHP) (also called: dioctyl phthalate, DOP). However, this additive is not suitable for polar polymers such as alginic acid and other polysaccharides. Low molecular weight or oligomeric polyalcohols such as glycols, glycerin and/or sorbitol are therefore preferably used as plasticizers to produce the mixture. These are non-toxic and biodegradable.

The components of the mixture are usually in liquid and/or powder form and are mixed together and homogenized in a suitable device, for example an extruder.

In the second step of the method, the mixture is spread flatly The mixture is applied directly to a carrier material by an application unit (e.g. a wide slot nozzle, a roller, etc.) or forms a free-standing film. However, direct application to the carrier material prevents bubbles from entering the mixture. A bubble-free film/coating is necessary to maintain its barrier function across the entire surface.

In the third step of the process, the mixture is dried. The aim of drying is to dry the flatly spread, moist alginate-based film in a dimensionally stable way both in length and width and at the same time quickly, namely, to remove the solvent from the alginate-based film with the lowest possible energy expenditure.

According to the invention, in an alternative embodiment, the mixture has a crosslinking system which has a crosslinking agent and a crosslinking control agent. The crosslinking agent contains the metal ions necessary for crosslinking in a dissociable form, while the crosslinking control agent can accelerate or delay the release of the metal ions into the solution, i.e. their conversion into the crosslinking form.

In a further development of the invention, a dissociable crosslinking agent is used and the crosslinking control agent has a higher affinity for salt formation with acid residue ions of the crosslinking control agent than with the acid residue ion of the crosslinking agent. A salt is added to the mixture as a crosslinking control agent; it captures the released ions of the crosslinking agent and thus prevents crosslinking of the alginate monomers. As soon as the crosslinking agent goes into solution, metal ions of the crosslinking agent are released, and as soon as the crosslinking control agent goes into solution, acid residue anions are released. The released metal ions of the crosslinking agent, together with the acid residue anions, form a byproduct that remains in the mixture.

In a further embodiment of the invention, the crosslinking control agent is suitable for delaying the ionic crosslinking of the alginate. A substance that captures the released ions of the crosslinking agent and thus delays crosslinking of the alginate carboxyl groups is added to the mixture as a crosslinking control agent. As soon as the crosslinking agent goes into solution, metal ions of the crosslinking agent are released, and as soon as the crosslinking agent goes into solution, acid radical anions are released. The released metal ions of the crosslinking agent, together with the acid residue anions, form a byproduct that remains in the mixture. This precipitation reaction takes place until all acid residue anions have reacted with metal ions of the crosslinking agent and have precipitated. Only then does the crosslinking reaction of the metal ions of the crosslinking agent with the alginic acid residue ion begin. The delay time depends on the relative concentrations of the crosslinking agent and the crosslinking control agent and can therefore be precisely adjusted by appropriately selecting the concentrations.

In a further aspect of the invention, the crosslinking control agent is added to the mixture prior to adding the solvent. The crosslinking reaction of the alginate chains in the mixture of alginate and crosslinking agent begins immediately after the solvent is added. After addition of the solvent, the mixture is liquid or at least viscous to gel-like. Adding the crosslinking control agent before adding the solvent impedes the crosslinking reaction of the alginate chains in the mixture. In a further development of the invention, the solvent is added last when preparing the mixture in order to delay the crosslinking reaction of the alginate chains as much as possible and to be able to determine the exact point in time at which the crosslinking reaction of the alginate chains starts.

In a further embodiment of the invention, the mixture is mixed in an extruder, preferably in a screw extruder. In particular, the mixture is mixed in the extruder continuously by feeding the individual components of the mixture into the extruder at a continuous rate. The most frequently used plasticizer in conventional plastics is, for example, diethylhexyl phthalate (DEHP) (also called: dioctyl phthalate, DOP). As a continuous process, it is primarily used to produce pipes, films, panels, plastic coatings for cables and profiles with a wide variety of cross-sections. A screw extruder generates the pressure required for extrusion through a screw shaft. The screw is located in the screw barrel. The inner diameter of this corresponds to the outer diameter of the screw. The outlet opening, which is responsible for shaping the extrudate, is located on the screw barrel.

In a further embodiment of the invention, the mixture is heated during mixing. The mixture is heated in order to reduce the viscosity of the mixture, making the mixture easier to spread flatly On the other hand, heating reduces the formation of bubbles in the mixture.

In a further embodiment of the invention, the mixture is mixed under negative pressure. This also reduces the formation of bubbles in the mixture.

In an advantageous embodiment of the invention, the flat spreading takes place through a wide slot nozzle. Slot die coating is a coating technique for applying thin layers of liquid to web-shaped substrates (paper, film, fabrics, etc.) or piece goods (glass, metal plates, etc.) In a further advantageous embodiment of the invention, the flat spreading is carried out by a roller. The roller achieves an even spreading of the mixture.

In a particularly advantageous embodiment of the invention, the flat spreading takes place on a carrier. In particular, the carrier is a flat, sheet-shaped substrate, which is designed such that after the mixture has dried, the alginate-based film produced can be detached from the carrier.

In a further particularly advantageous embodiment of the invention, the carrier is a paper, cardboard or molded pulp part, from which the alginate-based film produced cannot be removed.

In a further embodiment of the invention, the mixture has a moisture content of at least 50% after adding the solvent. In a further embodiment of the invention, the mixture has a moisture content of at least 95% after adding the solvent. This moisture content ensures that the mixture is flowable and the components in the mixture are homogenized. At the same time, the drying time is limited.

In a further embodiment of the invention, the film has a thickness of at least 20 μm, preferably at least 50 μm, particularly preferably at least 100 μm after the flat spreading. The flat spreading preferably has a thickness of at most 3 mm.

In a further embodiment of the invention, the mixture contains a material portion (comprising alginate and plasticizer) before the solvent is added

In a further development of the invention, the material portion before the solvent is added has an alginate portion of between 50 and 95% by weight, preferably between 65 and 90% by weight, particularly preferably between 75 and 85% by weight and a plasticizer portion between 5 and 50% by weight, preferably between 10 and 35% by weight, particularly preferably between 15 and 25% by weight.

In a further development of the invention, the crosslinking system has a crosslinking agent proportion before the solvent is added of between 10 and 90% by weight, preferably 20 and 80% by weight, particularly preferably 30 and 70% by weight, and a crosslinking control agent proportion of between 90 and 10% by weight, preferably 80 and 20% by weight, particularly preferably 70 and 30% by weight.

In a further embodiment of the invention, the mixture of alginate, plasticizer, solvent, crosslinking agent and crosslinking control agent has a solvent content of at most 95% by weight, preferably at most 90% by weight, particularly preferably at most 85% by weight.

The object is further achieved with the alginate-based film for use as packaging material according to claim 20. Further advantageous embodiments are also set forth in the dependent claims.

The alginate-based film according to the invention for use as a packaging material has an ionically crosslinked alginate. In addition, the alginate-based film has a crosslinking agent, a crosslinking control agent, a plasticizer and a solvent. It may also preferably contain substances that are formed by chemical reactions between the components of the mixture. Alginate has two types of monomers, mannuronic acid and guluronic acid, also called G blocks and M blocks. The alginate used in the process according to the invention for producing an alginate-based film contains M and G blocks in a ratio of preferably about 1:1.

The crosslinking agent starts the crosslinking of the G blocks and M blocks according to the principle of ionic crosslinking. The crosslinking agent is therefore preferably a salt that is readily soluble in the solvent used. The divalent Ca ion is preferably used to crosslink the alginate polymers. The resulting crosslinking with calcium is based on an ionic bond that is weaker than the covalent bond, which facilitates the biodegradation process.

Plasticizers are suitable for reducing the glass transition temperature as well as the hardness and brittleness of a plastic. Therefore, such an additive makes the plastics mixed with it easier to process and shape. Plasticizers can be called “molecular lubricants” in qualitative terms.

According to the invention, the alginate-based film additionally has salts which are formed by the solvent and a crosslinking control agent.

The crosslinking control agent captures the released ions of the crosslinking agent and prevents crosslinking of the alginate monomers for a certain period of time. As soon as the crosslinking agent goes into solution, metal ions of the crosslinking agent are released, and as soon as the polymerization inhibitor goes into solution, acid residue anions are released. The released metal ions of the crosslinking agent, together with the acid residue anions, form a salt that is insoluble in water and precipitates.

In a further embodiment of the invention, the alginate-based film has a moisture content between 0 and 30% by weight, preferably between 5 and 25% by weight and particularly preferably between 10 and 20% by weight.

In a further embodiment of the invention, the alginate-based film has a thickness of at least 5 μm, preferably 20 μm, particularly preferably between 40 μm.

The film has a thickness of at most 200 μm, preferably 100 μm, particularly preferably 70 μm.

In a further aspect of the invention, the standard deviation of the thickness of the alginate-based film is at most 10 μm, preferably at most 7 μm, particularly preferably at most 3 μm

Exemplary embodiments of the method according to the invention for producing an alginate-based film and the alginate-based film for use as packaging material are shown in a schematically simplified way in the drawings and are explained in more detail in the following description.

In particular:

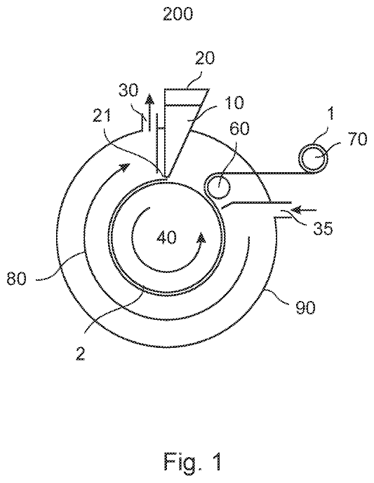

FIG. 1: shows a sectional view of a drum casting machine for producing an alginate-based film

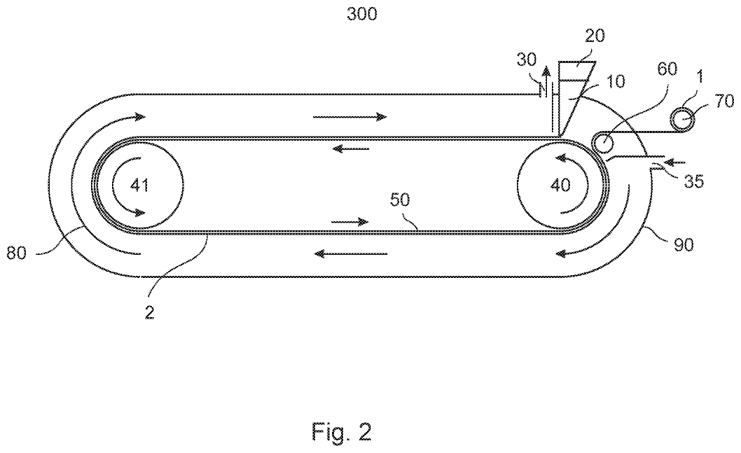

FIG. 2: shows a sectional view of a belt casting machine for producing an alginate-based film

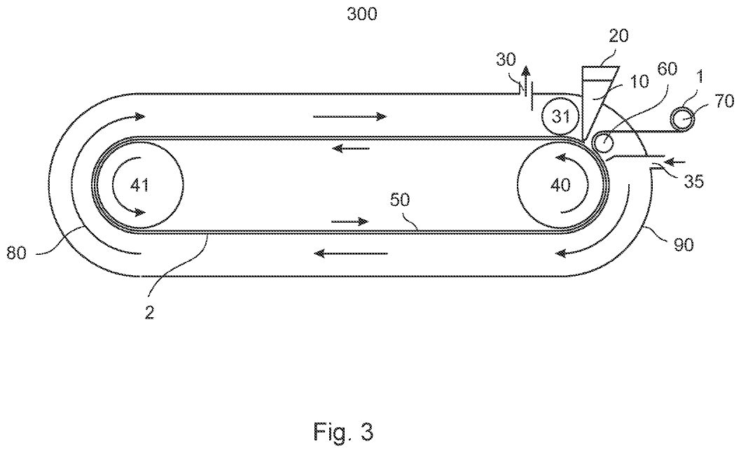

FIG. 3: shows a sectional view of a belt casting machine for producing an alginate-based film, flat spreading using a roller

FIG. 1 shows an exemplary embodiment of a drum casting machine 200 for producing the alginate-based film 1 according to the invention. The drum casting machine 200 has the caster 20, which contains the mixture 10 for producing the alginate-based film 1 according to the invention. The mixture 10 itself is prepared and mixed in an extruder (not shown), the extruder preferably being a screw extruder. The screw of the screw extruder continuously conveys the mixture 10 into the caster 20.

The mixture 10 is prepared continuously in the extruder by continuously mixing alginate, plasticizer, crosslinking agent and crosslinking control agent together. In addition, fillers or dyes are added in order, for example, to achieve a certain opacity or a certain color tone of the alginate-based film 1. The fillers mentioned are in powder form or as an aqueous slurry, the dyes mentioned are in powder form or liquid form.

Alginate has two types of monomers, mannuronic acid and guluronic acid, also called G blocks and M blocks. The alginate used contains M and G blocks in a ratio of approximately 1:1. In addition, mainly short-chain alginates are used in order to keep the solids content of the solution as high as possible with a lower viscosity compared to long-chain alginates. A lower viscosity leads to easier processability.

Plasticizers are suitable for reducing the glass transition temperature as well as the hardness and brittleness of a plastic. Therefore, such an additive makes the plastics mixed with it easier to process and shape. It is necessary for this purpose to use substances that can penetrate the plastic at the molecular level. This is the only way they can improve the mobility of the individual molecular chains relative to one another. In the present invention, glycols, glycerin and/or sorbitol are used as plasticizers. These materials are bio-based, compostable and biodegradable.

The crosslinking agents contain multivalent metal ions, but are free of heavy metals and, in the amount present, are harmless to the environment and the human body. The divalent Ca ion is preferably used to crosslink the alginate polymers. The resulting crosslinking with calcium is based on an ionic bond that is weaker than the covalent bond, which facilitates the biodegradation process. The crosslinking agent here is calcium sulfate.

The crosslinking control agent controls the crosslinking speed of the alginates, whereby two fundamentally different processes can be used: A substance can be added to the mixture 10 as a crosslinking control agent, which captures the released calcium ions of the crosslinking agent, here calcium sulfate, thus preventing crosslinking of the alginate monomers. A second possibility is to add an acid to the mixture 10, wherein the release of Ca ions from the crosslinking agent (here calcium carbonate) is controlled by the targeted dosage (type and concentration) of the acid. In the present invention, the former method is used, with sodium phosphate as the crosslinking control agent. As soon as the calcium sulfate goes into solution, Ca²⁺ions are released, and as soon as the sodium phosphate goes into solution, phosphate ions (PO₄³⁻) are released. The released Ca ions, together with the phosphate, form a salt, calcium phosphate (0.02 g/l at 25° C.), which is practically insoluble in water and precipitates. This precipitation reaction takes place until all phosphate ions have reacted with Ca ions and have precipitated. Only then does the reaction of the calcium with the residual alginic acid ion for crosslinking begin. The crosslinking control agent therefore delays the ionic crosslinking of the alginates until the mixture 10 is applied to the casting drum 40 after adding the solvent, water (deionized). The concentrations of crosslinking agent and crosslinking control agent are such that the crosslinking of the alginate begins exactly when the mixture 10 emerges from the caster 20 and hits the casting drum 40.

In all of the exemplary embodiments shown here, the solvent is deionized water and is added to the mixture 10 as the last component.

The mixture 10 is not only mixed and homogenized in the extruder, but is also degassed at the same time in order to minimize the formation of bubbles in the alginate-based film 1 during the manufacturing process. A bubble-free alginate-based film 1 is necessary to maintain its barrier function across the entire surface. Degassing takes place at a negative pressure of 10⁻² mbar. In addition, the extruder and the mixture 10 are heated to reduce the viscosity of the mixture 10 and to promote degassing. The temperature is 40° C.

The mixture 10 is applied flatly as a wet film 2 through a wide slot nozzle 21 arranged at the lower end of the caster 20 onto the casting drum 40, which rotates at a constant speed. The adjustable doctor blade 30 limits the thickness of the wet film 2 on the casting drum 40. The application thickness of the mixture 10 is 1 mm in this exemplary embodiment.

During the drying process, care is taken to ensure that drying occurs evenly within the wet film 2 in order to avoid tension forces occurring within the alginate-based film 1. Such tensions occur, for example, when the top side of the alginate-based film 1 has a lower solvent content than the bottom side.

In this and the following exemplary embodiments, the wet film 2 is dried by an air flow of dry air 80, which is conducted in the opposite direction to the direction of rotation of the casting drum 40. The air saturated with water vapor is continuously transported away above the wet film 2. The air flow to be adjusted and its temperature are tailored to the evaporation rate of the solvent (water). The casting drum 40 itself can also be heated. Alternatively, the wet film 2 can be dried in the area of the drum casting machine 200 between the guide roller 60 and the rewinder 70 using, for example, infrared radiators. Alternatively or additionally, the guide roller 60 itself can be heated. In order to enable uniform drying of the wet film 2 without skin formation on the surface, it is necessary that the wet film 2 has the same temperature at every point during drying, until the equilibrium moisture content with the ambient air at ambient temperature is reached.

The energy input into the wet film 2 is coordinated so that the water is removed from the wet film 2 at exactly the same speed so that no tension forces occur in the alginate-based film 1. The temperature of the drying process is additionally regulated in such a way that the temperature of the alginate-based film 1 does not exceed 130° C. This prevents the alginate-based film 1 from decomposing or discoloring. The air-dried alginate-based film 1 forms a continuous, transparent to milky-opaque film and is wound up on the rewinder 70. Since water is used as a solvent to make the mixture, no fume hood is necessary for drying. After drying, the thickness of the alginate-based film is 1,350 μm and its residual moisture is 20%.

By using a crosslinking system, one step is saved compared to the prior art, namely crosslinking in an additional crosslinking bath. The mixture 10 is produced continuously in the extruder (homogenized and degassed) and then applied to the casting drum, whereby both method steps, the production of the mixture 10 and the production of the alginate-based film 1, take place continuously.

An exemplary embodiment of a belt casting machine 300 for producing an alginate-based film 1 is shown in FIG. 2. In contrast to the previous exemplary embodiment (see FIG. 1), the belt casting machine 300 has two casting drums 41, 41, which are connected to one another by means of a belt-shaped carrier 50 in such a way that the casting drums 40, 41 have the same direction of rotation during operation.

The mixture 10 is prepared in the extruder as described in the previous exemplary embodiment (see FIG. 1) and conveyed into the caster 20. The mixture 10 is applied flatly as a wet film 2 through the wide slot nozzle 21 onto the band-shaped carrier 50, which is moved at a constant speed. The adjustable doctor blade 30 limits the thickness of the wet film 2 on the casting drum 40. The application thickness of the mixture 10 is also 1 mm in this exemplary embodiment.

The surface energy of the band-shaped carrier 50 is selected such that the applied wet film 2 (given a certain viscosity and formulation) completely wets the band-shaped carrier 50 and the wet film 2 can be removed again as a dry film 1 after drying. The band-shaped carrier 50 is designed in such a way that the applied wet film 2 remains dimensionally stable in width and length throughout the entire drying process. When the wet film 2 dries, only its thickness shrinks. The band-shaped carrier 50 used is a PET-based release film. After drying, the thickness of the alginate-based film 1 is also 350 μm.

FIG. 3 shows a variant of a belt casting machine 300 for producing an alginate-based film 1. The belt casting machine 300 corresponds to the belt casting machine 300 described in the previous exemplary embodiment (see FIG. 2) with only the doctor blade 30 for adjusting the thickness of the wet film 2 replaced by a rotating roller 31. The roller 31, like the doctor blade 30, is adjustable in height and also enables the thickness of the wet film 2 to be variably adjusted; in addition, the surface of the wet film 2 is smoothed by the roller 31.

### Formulation 1

10 g alginate is processed into a dispersion together with 0.5 g trisodium phosphate and 3 g glycerin in 90 g water. At the same time, 1 g of calcium sulfate is dissolved in 10 g of water. The two mixtures are combined in an extrusion screw heated to 50° C., where they are mixed to form a homogeneous, bubble-free mass and continuously extruded through a wide slot nozzle onto a rotating carrier material. The mixture is then dried at 90° C. and, in dried form, is removed from the carrier material and rolled up. The carrier material is a PET-based release film.

### Formulation 2

10 g of alginate are processed into a dispersion together with 90 g of water, 2 g of calcium carbonate and 2.5 g of glycerin. In parallel with this, 4 g of GDL (glucono-delta-lactone) are dissolved in 10 g of water. The two mixtures are combined in an extrusion screw at room temperature and mixed there to form a homogeneous, bubble-free mass and extruded continuously through a wide slot nozzle onto a rotating carrier material. The mixture is then dried at 100° C. and, in dried form, is removed from the carrier material and rolled up. The carrier material is a PET-based release film. The thickness of the applied wet film

### Formulation 3

10 g of alginate are processed into a dispersion together with 90 g of water, 2 g of calcium carbonate and 5 g of glycerin. In parallel with this, 4 g of GDL (glucono-delta-lactone) are dissolved in 10 g of water. The two mixtures are combined in an extrusion screw at room temperature and mixed there to form a homogeneous, bubble-free mass and extruded continuously through a wide slot nozzle onto a rotating carrier material. The mixture is then dried at 90° C. and, in dried form, is removed from the carrier material and rolled up. The carrier material is cardboard with a weight per unit area of 300 g/m². Alginate is applied as a biobarrier to provide the cardboard with a grease and oxygen barrier.

### LIST OF REFERENCE NUMERALS

1 alginate-based film
2 wet film
10 mixture
20 caster
21 wide slot nozzle
30 doctor blade
31 roller
40, 41 casting drum
50 conveyor belt
60 pulley
70 rewinder
80 dry air
90 airtight housing
100 band-shaped carrier film
200 drum casting machine
300 belt casting machine

1. A method for producing an alginate-based film (1) with the steps:
preparing a mixture (10),
wherein the mixture (10) comprises alginate, crosslinking agents, plasticizers and solvents as constituents,
spreading the mixture (10) flatly and
drying the mixture (10),
characterized in that
the mixture (10) contains a crosslinking agent and a crosslinking control agent.

2. The method for producing an alginate-based film (1) according to claim 1,
characterized in that
the crosslinking control agent has a higher affinity for salt formation with residual acid ions of the retarding salt than with the residual acid ion of the crosslinking agent.

3. The method for producing an alginate-based film (1) according to claim 1,
characterized in that
the crosslinking control agent is suitable for delaying the crosslinking of the alginate.

4. The method for producing an alginate-based film (1) according claim 1,
characterized in that
the crosslinking control agent is added to the mixture (10) before the solvent is added.

5. The method for producing an alginate-based film (1) according to claim 1,
characterized in that
when preparing the mixture (10), the solvent is added last.

6. The method for producing an alginate-based film (1) according to claim 1,
characterized in that
the mixture (10) is mixed in an extruder, preferably in a screw extruder.

7. The method for producing an alginate-based film (1) according to claim 1,
characterized in that
the mixture (10) is heated during mixing.

8. The method for producing an alginate-based film (1) according to claim 1,
characterized in that
the mixture (10) is mixed under negative pressure.

9. The method for producing an alginate-based film (1) according to claim 1,
characterized in that
the flat spreading takes place through a wide slot nozzle (21).

10. The method for producing an alginate-based film (1) according to claim 1,
characterized in that
the flat spreading is carried out by a roller (31).

11. The method for producing an alginate-based film (1) according to claim 1,
characterized in that
the flat spreading takes place on a carrier (100).

12. The method for producing an alginate-based film (1) according to claim 1,
characterized in that
the mixture (10) has a moisture content of at least 50% after adding the solvent.

13. The method for producing an alginate-based film (1) according to claim 1,
characterized in that
the mixture (10) has a moisture content of at most 95% after adding the solvent.

14. The method for producing an alginate-based film (1) according to claim 1 any one ore more of the preceding claims,
characterized in that
the film (1) after being spreading flat has a thickness of at least 20 μm, preferably at least 50 μm and particularly preferably at least 100 μm and/or a maximum thickness of 3 mm.

15. The method for producing an alginate-based film (1) according to claim 1,
characterized in that
the film (1) undergoes a decrease in film thickness of at least 50 um during the drying process.

16. The method for producing an alginate-based film (1) according to claim 1,
characterized in that
the mixture (10) has an alginate content of between 40 and 99.5% by weight of the mixture of alginate and plasticizer before the solvent is added.

17. The method for producing an alginate-based film (1) according to claim 1,
characterized in that
the mixture (10) has a plasticizer content of between 5 and 50% by weight of the mixture of alginate and plasticizer before the solvent is added.

18. The method for producing an alginate-based film (1) according to claim 1,
characterized in that
before adding the solvent, the mixture (10) has a crosslinking system consisting of a crosslinking agent and a crosslinking control agent in a proportion of between 0.5 and 60% by weight of the mixture of alginate, plasticizer and crosslinking system.

19. The method for producing an alginate-based film (1) according to claim 1,
characterized in that
the mixture (10) has solvents in a proportion of between X % by weight and Y % by weight of the mixture of alginate, plasticizer, solvent and crosslinking control agent.

20. An alginate-based film (1) for use as a packaging material, which has:
ionically crosslinked alginate
plasticizer
solvent
characterized in that
the alginate-based film (1) according to the invention additionally contains salts which are formed by the solvent and a crosslinking control agent.

21. The alginate-based film (1) for use as packaging material according to claim 20,
characterized in that
the alginate-based film (1) has a moisture content between X % by weight and Y % by weight.

22. The alginate-based film (1) for use as packaging material according to claim 20,
characterized in that
the alginate-based film (1) has a thickness between X μm and Y μm.

23. The alginate-based film (1) for use as packaging material according to claim 22,
characterized in that
the standard deviation of the thickness of the alginate-based film (1) is between X and Y.
